(19) United States
(12) Patent Application Publication
(10) Pub. No.: US 2011/0248095 A1
(43) Pub. Date: Oct. 13, 2011

(54) VARIABLE ORIFICE BLACK LIQUOR NOZZLE METHOD AND APPARATUS

(75) Inventors: Mohomed Ishaq Jameel, Beaverton, OR (US); Kenneth A. Pingel, Hillsboro, OR (US)

(73) Assignee: CLYDE BERGEMANN, INC., Beaverton, OR (US)

(21) Appl. No.: 13/089,205

(22) Filed: Apr. 18, 2011

Related U.S. Application Data
(63) Continuation-in-part of application No. 11/766,030, filed on Jun. 20, 2007, now Pat. No. 7,926,747.
(60) Provisional application No. 60/805,460, filed on Jun. 21, 2006.

(51) Int. Cl. B05B 17/04

(52) U.S. Cl. 239/11; 239/436

(57) ABSTRACT

A nozzle for the spraying of black liquor in a recovery boiler has discharge orifice inserts that can be removed and replaced with other inserts, to provide variable spray patterns, by changing the size and/or shape of the orifice of the nozzle, without requiring replacement of the entire nozzle body, to enable fine tuning of the atomization of the spray. Adjustment of the orifice height provides adjustment of the atomization and the spray angle of the discharge.

### CROSS-REFERENCE TO RELATED APPLICATIONS

This application is a continuation-in-part of U.S. patent application Ser. No. 11766030 filed Jun. 20, 2007, and claims priority from U.S. provisional patent application 60805460, filed Jun. 21, 2006.

### FIELD OF INVENTION

The present invention relates to nozzles used for the injection and atomization of black liquor that is combusted in a chemical recovery boiler.

### BACKGROUND OF THE INVENTION

Black liquor is a fluid that is the by product of the pulping process. This fluid contains both organic and inorganic material resulting from the pulping of wood. Black Liquor is burnt in a special boiler where the heat from the organic matter is used to generate steam and the inorganic matter is reduced to extract the pulping chemicals which are then returned to the pulping process. In order to ensure the proper combustion and chemical recovery the liquor has to be atomized to an optimum droplet size. This depends on the physical properties of the black liquor and boiler geometry as well as operating parameters such combustion air flow, liquor flow rate, injection pressure and temperature.

In accordance with the prior art, black liquor is sprayed into the boiler through dedicated nozzles. FIG. 1 is a schematic of the most widely used nozzle, the splash plate 10. Other nozzles types that have been used are used the V-jet 20 shown in FIG. 2 and more recently the beer can 30 shown in FIG. 3. The latter has come about as a result of new developments in boiler combustion.

In the case of the splash plate nozzle the black liquor is delivered through the pipe 14 which is mounted to the inlet orifice 11 on the nozzle body 13. The fluid leaves the nozzle through the discharge orifice 12. Both the inlet and discharge orifices 11 and 12 are an integral part of the nozzle body 13. The fluid upon leaving the orifice impacts on the splash plate 15 where it spreads out to form a sheet that eventually breaks up into droplets that burn.

For the V-jet nozzle 20 the fluid is delivered through pipe 24 which is mounted to the inlet orifice 21 found on the nozzle body 23. The fluid leaves the nozzle through the discharge orifice 22. Both the inlet and discharge orifices 21 and 22 are an integral part of the nozzle body 23. Fluid traveling through the discharge orifice contracts and spreads out like a fan forming a thin sheet that eventually breaks up into droplets that burn.

For the rotary atomizer/beer can nozzle 30 the fluid is delivered through pipe 34 which is mounted to the inlet orifice 31 found on the nozzle body 33. The fluid leaves the nozzle through the discharge orifice 32. Both the inlet and discharge orifices 31 and 32 are an integral part of the nozzle body 33. Fluid traveling through the inlet orifice 31 travels down a small transition channel 35 and enters the inner cavity 36 of the nozzle body 33 at a point tangential to the cavity wall. The fluid swirls around the cavity and eventually leaves the nozzle body 33 through the discharge orifice 32 found at the bottom of the nozzle body. The fluid leaving the discharge orifice spreads like a cone which eventually breaks up into droplets that burn.

### SUMMARY OF THE INVENTION

In accordance with the invention, a nozzle for the spraying of black liquor in a recovery boiler is provided, where the discharge orifice of the nozzle can easily be varied without having to change the entire nozzle. This enables one to fine tune the atomization to the specific combustion setup at that time and place. The orifice height is varied to control the spray angle and characteristics to desired configurations.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

FIG. 1: Cross section of prior art splash plate nozzle.

FIG. 2: Cross section of prior art V-jet nozzle.

FIG. 3: Schematic of prior art beer can nozzle.

FIG. 4: Cross section of variable orifice beer can.

FIG. 5A: Bottom view of the discharge end of the variable orifice beer can.

FIG. 5B: Detail view of roll pin and orifice disk from FIG. 5A.

FIG. 6: Exploded perspective view of variable orifice beer can employing alternative.

FIG. 7: Exploded perspective view of another variable orifice beer can employed with variable height orifice insert.

FIG. 8: Another perspective view of a beer can nozzle without insert in place.

FIG. 9: Views comparing a standard 3/16″ orifice (9A) with a thicker orifice of height E (9B).

FIG. 10: Cross section of variable height orifice beer can of FIG. 7.

FIGS. 11, 12 and 13: Views of example spray patterns with different height orifices.

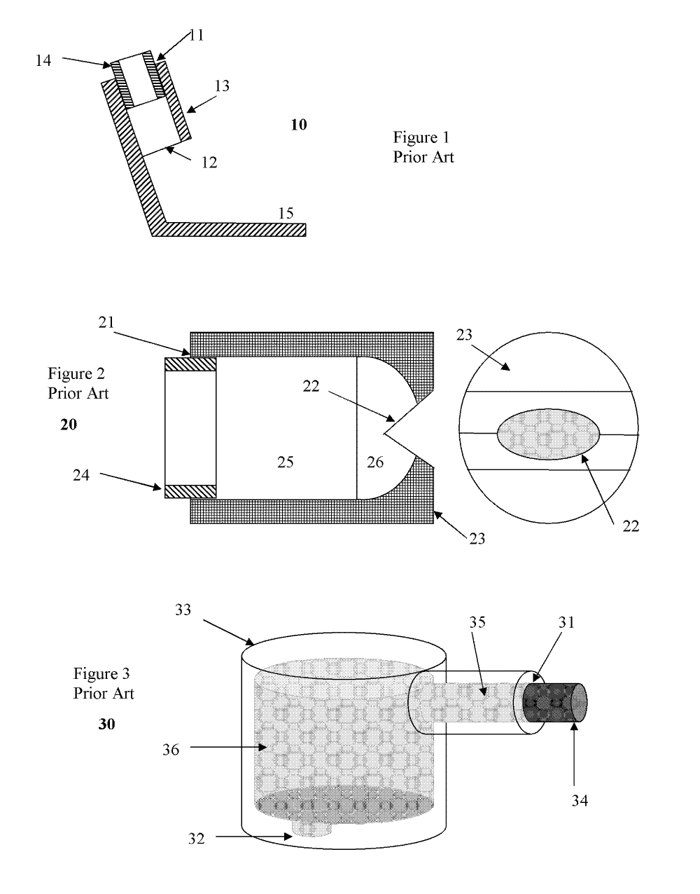

### DETAILED DESCRIPTION

In order to optimize the combustion and chemical reduction it may be necessary for one to change the orifice size to vary the injection pressure or vary the flow rate. For all of the prior art nozzles above, the discharge orifice is an integral part of the nozzle body which would therefore require one to change the entire nozzle body in order to change the orifice. In another instance it may be necessary to change the orifice due to wear which results in the increase in flow area and/or change in shape. With the nozzle arrangement in accordance with the invention disclosed here one has to only change a single piece that bears the opening for the discharge orifice in order to change the orifice size.

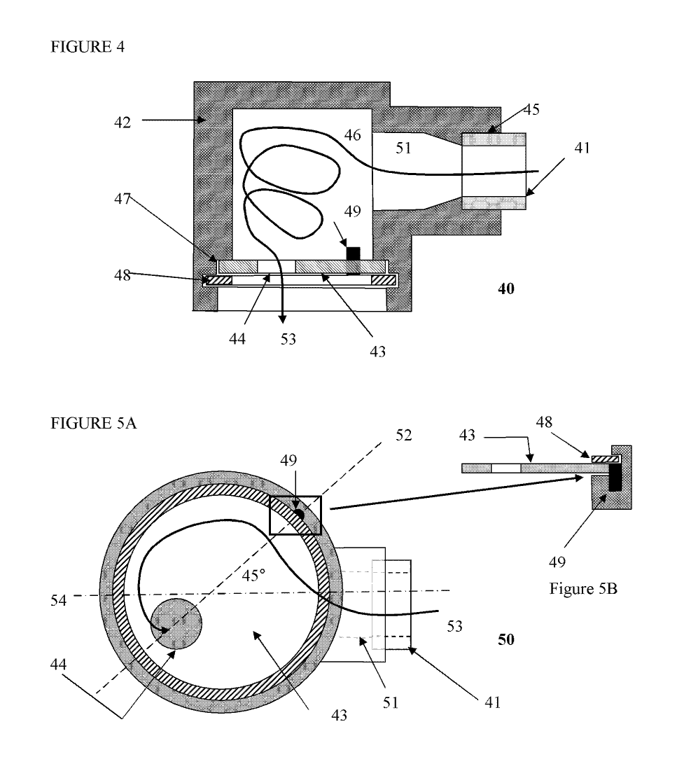

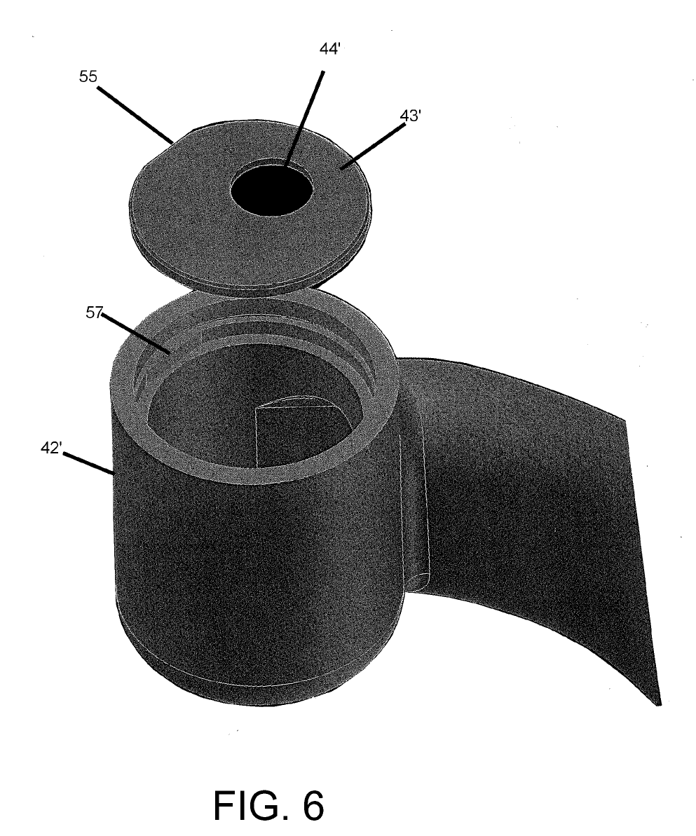

FIGS. 4 & 5 show the arrangement of a beer can type nozzle 40 in accordance with this invention. FIG. 4 shows the cross section through the nozzle while FIG. 5A shows a view of the bottom end of the nozzle 50 with the details for the variable orifice. FIG. 5B gives a more details view of a section of the arrangement in FIG. 5A. In the case of the beer can nozzle 40 the fluid is delivered through a pipe 41 which is mounted to the inlet orifice 45 found on the nozzle body 42. According to FIG. 5A the fluid entering through 41 travels through the passage 51 and enters the body at the top of the inner cavity 46 of the nozzle while traveling tangent to its wall. The fluid swirls around the inner cavity as illustrated by the path 53 and is finally ejected through the orifice the orifice 44. The orifice is made by drilling a hole on the orifice disk 43. Unlike the prior art 30 in FIG. 3, this disk is not an integral part of the nozzle body 42. It is a totally independent component which is placed in a recess at the exit end of the nozzle. When the nozzle is in use the orifice disk faces down. A snap ring 48 prevents it from falling out of the nozzle body. In order to achieve the swirling flow inside the nozzle the discharge orifice should lie rotationally in the quadrant furthest away from the inlet orifice. In order to maintain this position the orifice plate is held securely by pin 49 that has part of its circumference engaged with disk 43 while the remainder engaged with the housing 42. In liu of the pin a flat face 55 could be cut on the perimeter of the disk 43′, as illustrated in FIG. 6, a perspective view of an alternative beer can type nozzle body 42′ and discharge disk. A corresponding flat face 57 would be cut in the nozzle body 42′ as well. In either case, the pin or flat face and the orifice hole are set 180° apart and the lie along the line 52 which is at an angle of 45° from the center line 54 of the inlet orifice. The pin is inserted into a hole in the housing. The depth of the hole is selected such that the pin does not protrude beyond the surface of the disk. It is important to have the pin flush with the outer surface of the disk in order to properly seat the snap ring. While it is possible to hold the disk by cutting a male thread on the edge of the disk corrosion and thread distortion due to heat does not make it very practical. In order to enable one to operate the nozzle in the environment of a chemical recovery boiler while maintaining the ability to change the orifice diameter by swapping out the orifice disk the nozzle housing are made of different materials which have substantially different thermal expansion coefficients. The thermal expansion coefficient of the disk is greater than that of the nozzle housing. The disk diameter and the recess diameter in the nozzle body are carefully controlled so that at room temperature (˜20° C.) a specific gap 47 is maintained between the two of them. The black liquor delivered to the nozzle is in the range of 100-130° C. Therefore at elevated temperatures the disk would expand more than the housing hence closing the gap 47 ensuring a seal of the inner chamber 46. When the nozzle is taken out of service and the temperature lowered to room temperature the disk will shrink to its original size which in turn will enlarge the clearance between these two components enabling one to swap out the disk thereby changing the orifice diameter.

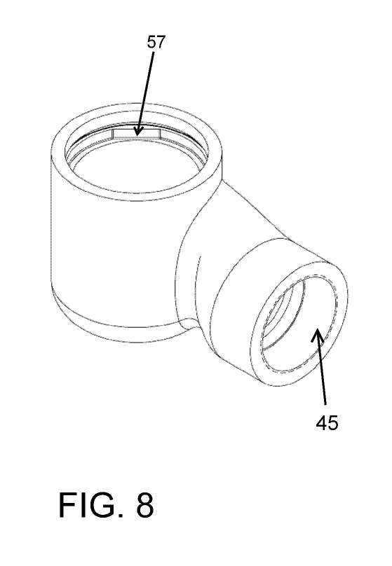

FIG. 8 is another perspective view of a beer can type nozzle body, where the flat face portion 57 (or other suitable geometric feature to provide indexing or keying of insert placement) is observable.

In accordance with the invention, a nozzle arrangement is provided to enable changing of orifice properties to adjust flow and spray pattern without requiring the replacement of the entire nozzle body. This can provide lower cost operation and maintenance, for example. Further, the orifice properties may be changed to provide desired drop sizes and droplet velocities in the spray for optimum combustion in the recovery boiler.

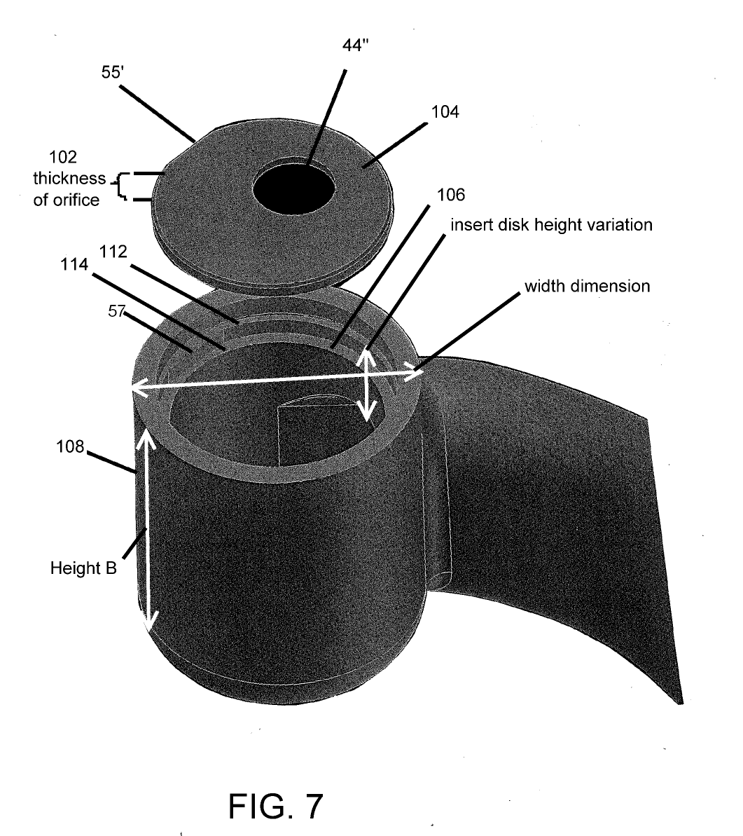

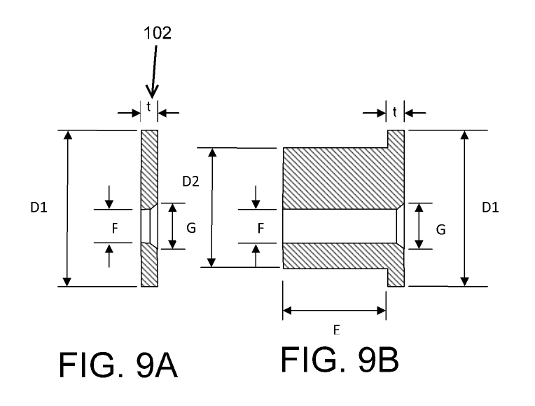

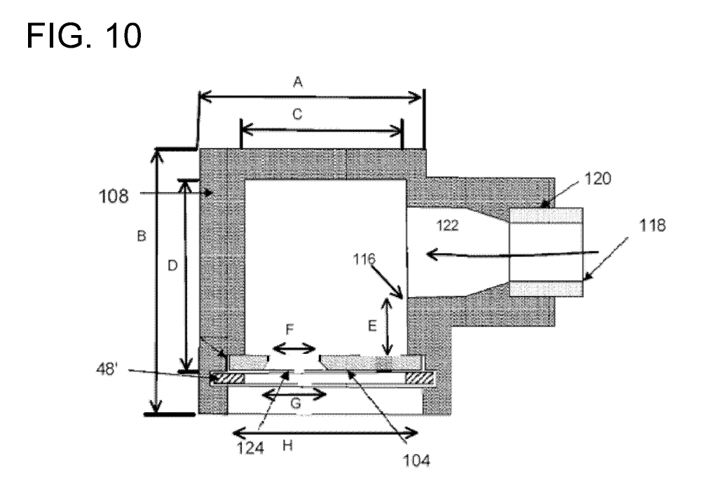

Varying the height of the orifice insert can provide adjustment and variation to the resulting spray pattern. FIG. 7 is an exploded perspective view of another variable orifice beer can (viewed from the discharge side) employed with standard orifice insert, wherein the height 102 of insert disk 104 will sit on seat 106 that is formed in the interior of the nozzle body 108, where the height 110 between the outer edge 112 and the inner face 1114 is the same as the orifice height 102. FIG. 9A shows a cross section of disk 104, suitably a standard insert disk of minimum thickness. The orifice height 102 is given by the thickness t= 3/16″. The exit diameter G of the orifice is suitably larger than the inlet diameter F, with an inwardly decreasing diameter defined by a bevel to half the thickness of the insert thickness t, whereupon the diameter F continues inwardly (defining a substantially 90 degree angle of the orifice walls) to the inlet face. FIG. 9B is the cross section of the variable height orifice disk. This orifice disk that has one end the corresponding features to the disk as shown in FIG. 9A, having a diameter D1 together with a cylindrical section having a height E and a diameter D2<D1, D2 chosen as slightly less than the diameter C of the beer can interior cavity, to allow for insertion into the cavity. The height E may be varied to provide adjustment of the discharge spray angle and characteristics. The maximum height E is the depth to where the inner face of the orifice disk just reaches position 116 (FIG. 10), where the insert and seat reach the opening of passage 122 from which the supply of the sprayed material will enter the nozzle chamber. By changing the height (or thickness) of the insert disk, the spray angle and characteristics can be changed. The section of diameter D1 will still fit into the same seating area in the nozzle as the standard disk 102 shown in FIG. 7.

FIG. 10 is a cross section of variable height orifice beer can of FIG. 7, fluid entering the nozzle through pipe 118 which is mounted to the inlet orifice 120 found on the nozzle body, travels through the passage 122 and enters the body at the top of the inner cavity of the nozzle while traveling tangent to its wall. The fluid swirls around the inner cavity and is finally ejected through the orifice 124. The orifice is made by forming a hole on the orifice disk 104, wherein the hole is beveled to be wider at the output side than at the input side.

Suitable dimensions in a particular embodiment include: diameter A of body, 3″, height B of body, 3.38″, diameter C of interior body cavity, 2.25″, height D of interior body cavity, 3″, based on the variation of the thickness of the orifice disk the span E can vary from 0″ to 0.45″, diameter F of interior face opening of orifice could range from, 12/32″ to 48/32″, diameter G of exterior face opening of orifice is given typically given by the relation G=F+ 3/16″, diameter H of exterior opening of body, 2.5″. Diameter D2 is slightly less than the interior diameter C interior body cavity of the beer can nozzle such that the nozzle insert may be fitted into the interior body cavity.

While in the preferred embodiment, D2 is chosen as slightly less than but very close to the diameter C of the can interior to allow insertion and removal of the insert, D2 can be varied such that D2>F+sufficient thickness to provide rigidity not collapse in use, up to D2=C−fit tolerance. Other nozzles with different sizes are also suitable. The specific dimensions may be varied depending on flow rate desired and fluid viscosity. The outer diameter B of the can should be smaller than the diameter of the opening in the boiler wall so that the can may fit into the boiler without requiring boiler modifications.

As noted, by controlling the height of the orifice (suitably by controlling the thickness of the insert orifice disk, the spray angle of the discharge spray can be controlled. Suitable values of orifice height and resulting spray angles measured are provided below.

### EXAMPLES

A nozzle body in accordance with FIGS. 7, 9A, 9B and 10 was mounted in an elevated position with a pressurized water supply provided thereto. The nozzle bodies with varying height orifice insert disks were tested and the resulting spray patterns and spray angles were observed.

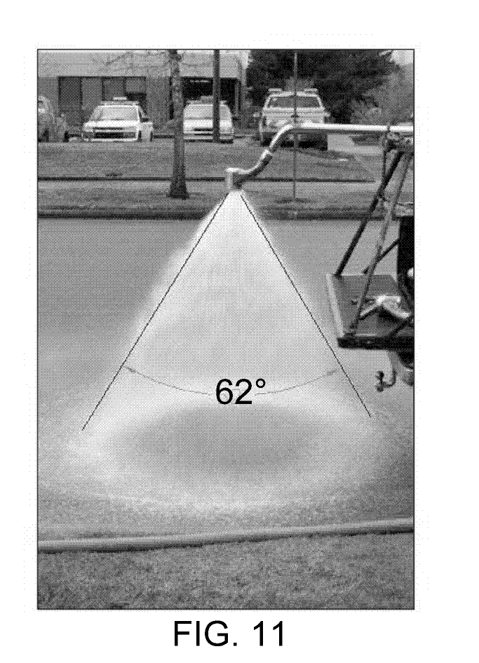

Example 1—orifice height 4.7 mm ( 3/16 inch), orifice diameter 32 mm—spray angle 62 degrees. See FIG. 11, a photograph of a resulting spray test.

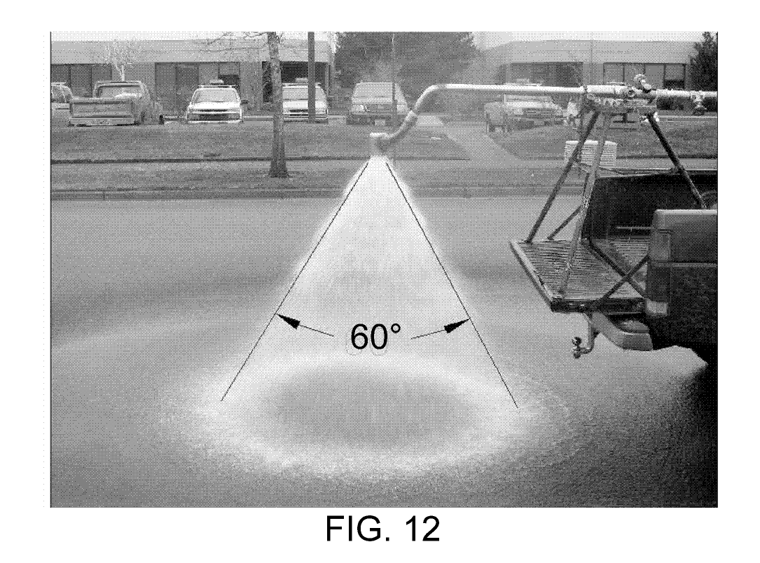

Example 2—orifice height 12 m (½ inch), orifice diameter 32 mm—spray angle 60 degrees. The spray cone appears round and well developed. Material within the spray cone appears well balanced and without noticeable weak or heavy zone. See FIG. 12, a photograph of a resulting spray test.

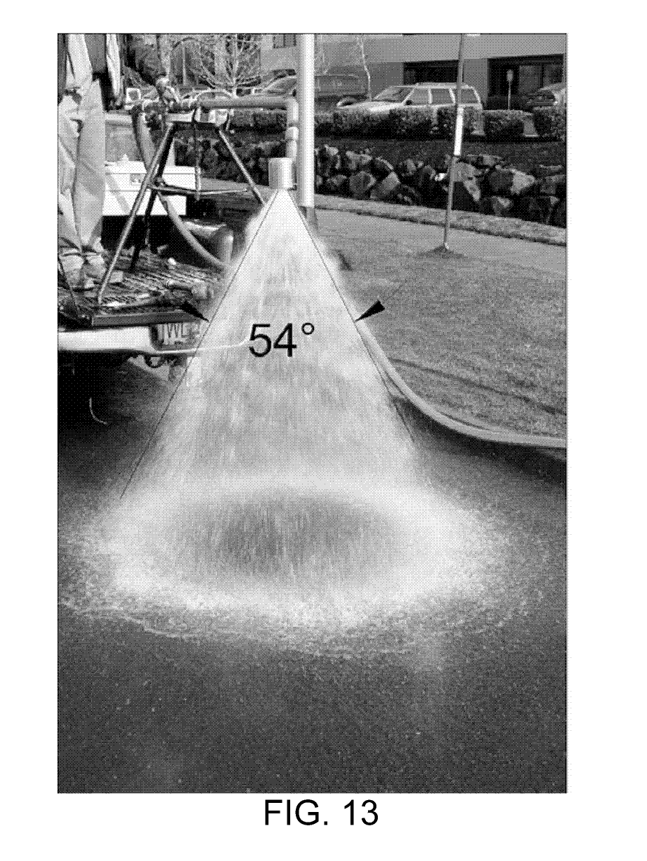

Example 3—orifice height 25 mm (1 inch), orifice diameter 32 mm—spray angle 54 degrees. The spray cone appears round and well developed. Material within the spray cone appears well balanced and without noticeable weak or heavy zone. See FIG. 13, a photograph of a resulting spray test. The spray droplets appear to be getting coarser as the spray angle is reduced. The coarser droplets appear to give a more pronounced splash zone on the ground.

Variation of the orifice height also has an impact on the flow rate, as measured in these examples:

Example 1—orifice diameter F, 32 mm, height 4.7 mm ( 3/16 inch), at pressure of 138 kPa (20 psig), a flow rate of 24.1 m³/h (106 GPM) was measured.

Example 5—orifice diameter F, 32 mm, height 25.4 mm (1 inch), at pressure of 138 kPa (20 psig), a flow rate of 22.9 m³/h (101 GPM) was measured.

Accordingly, the spray angle may be modified by modifying the height of the orifice through which the spray discharges from the nozzle body.

While plural embodiments of the present invention have been shown and described, it will be apparent to those skilled in the art that many changes and modifications may be made without departing from the invention in its broader aspects. The appended claims are therefore intended to cover all such changes and modifications as fall within the true spirit and scope of the invention.

What is claimed is:

1. A method for providing adjustment of spray angle in a nozzle, comprising:
providing a nozzle body for receiving a fluid supply thereto and for discharging the fluid supply;
providing a receiving portion for an insertable orifice member for defining the spray discharge orifice; and
inserting an orifice member into the receiving portion.

2. The method according to claim 1, further comprising adjusting the height of the orifice member to alter spray angle and droplet size of discharge from the nozzle.

3. The method according to claim 2, wherein said adjusting comprises adjusting the height from 4.76 mm ( 3/16″)to 25.4 mm (1″).

4. The method according to claim 1, wherein said providing a nozzle body comprises providing a nozzle body with a cylindrical interior cavity, a fluid supply inlet at a side opening to said interior cavity, and providing a receiving portion comprises providing a receiving seat defined at a periphery of the cylindrical interior cavity.

5. The method according to claim 4, wherein said orifice member comprises an orifice having a height ranging from 4.8 mm ( 3/16″) to 25.4 mm (1″).

6. A method for providing adjustment of spray angle in a nozzle, comprising:
providing a nozzle body for receiving a fluid supply thereto at an inlet thereof and for discharging the fluid supply, said nozzle body having an inner cavity for providing for fluid to swirl around the inner cavity;
providing a receiving portion for an insertable orifice member for defining spray discharge orifice at a fluid outlet of the nozzle body; and
inserting an orifice member into the receiving portion for providing a spray discharge orifice to the nozzle.

7. The method according to claim 6, further comprising adjusting the height of the orifice member to alter spray angle of discharge from the nozzle, wherein said adjusting comprises adjusting the height to a value between 0 to 1″.

8. The method according to claim 6, wherein said nozzle body inner cavity comprises a cylindrical interior cavity.

9. The method according to claim 6, wherein providing a receiving portion comprises providing a receiving seat defined at a periphery of the interior cavity.

10. The method according to claim 9, further comprising adjusting the height of the orifice member to alter spray angle of discharge from the nozzle, wherein said adjusting comprises adjusting the height to a value between 0 to 1 inches.

11. A nozzle for spraying in a boiler capable of operating with multiple orifice sizes and shapes while using the same nozzle body, comprising:
a nozzle body, said nozzle body having
an interior cavity having a first interior dimension; and
an insert receiving portion having a second interior dimension larger than said first interior dimension and a first height dimension; and
a nozzle insert adapted for insertion at said insert receiving portion, said nozzle insert defining a discharge orifice and having a dimension less than the first interior dimension sufficient for fitting insertion of said nozzle insert at said insertion receiving portion.

12. The nozzle according to claim 11, wherein said nozzle insert defines a discharge orifice for allowing discharge from the interior cavity of said nozzle body to an exterior.

13. The nozzle according to claim 11, wherein said nozzle insert further comprises an interior cavity fitting portion having a dimension at most approaching the first interior dimension of said interior cavity for fitting engagement within said cavity, said interior cavity fitting portion having a height dimension extending inwardly to said interior cavity for defining an orifice height dimension.

14. The nozzle according to claim 11, wherein said nozzle insert defines a discharge orifice for allowing discharge from the interior cavity of said nozzle body to an exterior.

15. The nozzle according to claim 14, wherein said nozzle insert has a first portion having a thickness of at least 3/16^{th} inch, and said interior cavity fitting portion has a thickness of 0 to 1 inch.
